(19) United States
(12) Patent Application Publication
(10) Pub. No.: US 2025/0201833 A1
(43) Pub. Date: Jun. 19, 2025

(54) ELECTRODE MATERIALS COMPRISING AN FE-DOPED TUNNEL-TYPE OXIDE OF SODIUM, LITHIUM, MANGANESE AND METAL, ELECTRODES COMPRISING SAME AND USE THEREOF IN ELECTROCHEMISTRY

(71) Applicant: HYDRO-QUÉBEC, Montréal (CA)

(72) Inventors: Yuesheng WANG, Candiac (CA); Julie TROTTIER, Mirabel (CA); Chisu KIM, Longueuil (CA)

(21) Appl. No.: 18/848,031

(22) PCT Filed: Apr. 6, 2023
(86) PCT No.: PCT/CA2023/050475

§ 371 Date: Sep. 17, 2024

Related U.S. Application Data
(60) Provisional application No. 63/362,616, filed on Apr. 7, 2022.

(51) Int. Cl. H01M 4/505; H01M 4/02; H01M 4/131; H01M 4/38; H01M 4/62; H01M 10/0525; H01M 10/0562; H01M 10/0565; H01M 10/0568

(52) U.S. Cl. CPC H01M 4/505; H01M 4/131; H01M 4/381; H01M 4/623; H01M 4/625; H01M 10/0525; H01M 10/0562; H01M 10/0565; H01M 10/0568; H01M 2004/027; H01M 2004/028; H01M 2300/0071; H01M 2300/0082

(57) ABSTRACT

The present technology relates to electrochemically active materials comprising a lithium-substituted iron-doped tunnel-type oxide of sodium, manganese, and at least one metallic element of formula NaₐLi_{b}Fe_{c}Mn_{d}MeO₂, wherein a is a number such that 0<a<0.22; b is a number such that 0.18<b<0.40 and is such that a+b is 0.38<a+b<0.62; c is a number such that 0<c≤0.40; d is a number such that 0.44 s d<1; e is a number such that c+d+e=1; and M is selected from manganese (Mn), titanium (Ti), vanadium (V), nickel (Ni), cobalt (Co), chromium (Cr), molybdenum (Mo), zirconium (Zr), tin (Sn), ruthenium (Ru), other similar metals, and a combination of at least two thereof. Also described are electrode materials, electrodes, electrochemical cells, and batteries comprising said electrochemically active materials.

### RELATED APPLICATION

This application claims priority, under the applicable law, to U.S. Provisional Patent Application No. 63/362,616 filed on Apr. 7, 2022, the content of which is incorporated herein by reference in its entirety and for all purposes.

### TECHNICAL FIELD

The present application generally relates to the field of electrochemically active materials and their uses in electrochemical applications. More particularly, the present application relates to electrode materials comprising a tunnel-type oxide of sodium, magnesium and at least one metal partially substituted with lithium as an electrochemically active material, electrodes comprising them, their manufacturing processes and their use in electrochemical cells.

### BACKGROUND

One of the main drawbacks of the positive electrode materials currently used commercially in lithium-ion batteries (LIBs) and so-called all-solid-state batteries, such as LiCoO₂, LiNi_{0.33}Mn_{0.33}Co_{0.33}O₂(NMC 111), LiNi_{0.6}Mn_{0.2}Co_{0.02}O₂(NMC 622), and LiNi_{0.8}Mn_{0.1}Co_{0.1}O₂ (NMC 811), is their high production cost. The raw materials used in the manufacture of positive electrode materials are becoming increasingly important in the total cost of the battery, which could be problematic for the growth in market share of LIBs and so-called all-solid-state batteries. For example, the weighted average price of cobalt could limit future applications for LIBs and all-solid-state batteries. Positive electrode materials containing reduced amounts of cobalt and cobalt-free positive electrode materials therefore attract a great deal of attention, particularly in large-scale and high energy density energy storage systems. For example, lithium iron phosphate (LiFePO₄ or LFP) has attracted a great deal of interest due to the cost-effectiveness of its materials. However, the energy density of LFP batteries has not improved sufficiently to meet the demands of the electric vehicle market.

Accordingly, there is still a need for the development of new electrode materials that exclude one or more of the disadvantages of conventional commercial positive electrode materials. For example, there is a need for the development of new low-cost, high-capacity, high-voltage positive electrode materials for LIBs and so-called all-solid-state batteries.

### SUMMARY

According to one aspect, the present technology relates to an electrochemically active material comprising a lithium-substituted iron-doped tunnel-type oxide of sodium, manganese, and at least one metallic element of formula NaₐLi_{b}Fe_{c}Mn_{d}MeO₂, wherein a is a number such that 0<a<0.22; b is a number such that 0.18<b<0.40 and is such that a+b is 0.38<a+b<0.62; c is a number such that 0<c<0.40; d is a number such that 0.44≤d<1; e is a number such that c+d+e=1; and M is selected from manganese (Mn), titanium (Ti), vanadium (V), nickel (Ni), cobalt (Co), chromium (Cr), molybdenum (Mo), zirconium (Zr), tin (Sn), ruthenium (Ru), other similar metals and a combination of at least two thereof.

According to one example, M is selected from manganese (Mn), titanium (Ti), vanadium (V), nickel (Ni), cobalt (Co), chromium (Cr), molybdenum (Mo), zirconium (Zr), ruthenium (Ru), other similar metals and a combination of at least two thereof. According to an example of interest, M is titanium (Ti).

According to another example, a is a number such as 0.01<a<0.22, or 0.02<a<0.22, or 0.03<a<0.22, or 0.04<a<0.22, or 0.05<a<0.22, or 0.06<a<0.22, or 0.07<a<0.22, or 0.08<a s 0.21. According to an example of interest, a is a number such that 0.08 s a s 0.21.

According to another example, b is a number such that 0.19<b<0.40, or 0.20 s b<0.40, or 0.20 s b<0.39, or 0.20 s b s 0.38. According to an example of interest, b is a number such that 0.20 s b s 0.38.

According to another example, c is a number such as 0.05<c≤0.40, or 0.10<c≤0.40, or 0.15<c≤0.40, or 0.20<c≤0.40, or 0.25<c≤0.40, or 0.30 s c s 0.40. According to an example of interest, c is a number such that 0.30 s c s 0.40.

According to another example, d is a number such that 0.44≤d<1, or 0.44≤d<0.95, or 0.44 s d<0.90, or 0.44<≤d<0.85, or 0.44<≤d<0.80, or 0.44<≤d<0.75, or 0.44<≤d<0.70, or 0.44<d<0.65, or 0.44≤d<0.60, or 0.44≤d≤0.55. According to an example of interest, d is a number such that 0.44≤d≤0.55.

According to another example, the lithium-substituted iron-doped tunnel-type oxide of sodium, manganese, and at least one metallic is selected from the group consisting of Na_{0.10}Li_{0.33}Fe_{0.34}Mn_{0.44}Ti_{0.22}O₂, Na_{0.08}Li_{0.38}Fe_{0.30}Mn_{0.55}Ti_{0.15}O₂, Na_{0.20}Li_{0.24}Fe_{0.34}Mn_{0.55}Ti_{0.11}O₂, Na_{0.21}Li_{0.20}Fe_{0.40}Mn_{0.50}Ti_{0.10}O₂, Na_{0.10}Li_{0.40}Fe_{0.08}Mn_{0.8}, Ti_{0.11}O₂, and Na_{0.10}Li_{0.40}Fe_{0.11}Mn_{0.78}Ti_{0.11}O₂.

According to another aspect, the present technology relates to an electrode material comprising the electrochemically active material as defined herein.

According to one embodiment, said electrode material further comprises an electronically conductive material. According to one example, the electronically conductive material is selected from the group consisting of carbon black, acetylene black, graphite, graphene, carbon fibers, carbon nanofibers, carbon nanotubes, and a combination of at least two thereof. According to an example of interest, the electronically conductive material comprises carbon black. For example, the carbon black is Super P™ carbon or Ketjen™ carbon. According to another example of interest, the electronically conductive material comprises carbon fibers. For example, the carbon fibers are vapor grown carbon fibers (VGCFs).

According to another embodiment, said electrode material further comprises a binder. According to one example, the binder is selected from the group consisting of a polyether type polymer binder, a fluorinated polymer, and a water-soluble binder. According to an example of interest, the binder is a fluorinated polymer. For example, the fluoropolymer is polyvinylidene fluoride (PVDF).

According to another embodiment, said electrode material further comprises an additive.

According to one example, the additive is selected from the group consisting of ionic conductors, inorganic particles, glass particles, ceramic particles, salts, and other similar additives.

According to another aspect, the present technology relates to an electrode comprising the electrode material as defined herein on a current collector.

According to one embodiment, the electrode is a positive electrode.

According to another aspect, the present technology relates to an electrochemical cell comprising a negative electrode, a positive electrode and an electrolyte, wherein the positive electrode is as defined herein.

According to one embodiment, the negative electrode comprises an alkali metal, an alloy comprising an alkali metal or a prelithiated electrochemically active material. According to one example, the negative electrode comprises metallic lithium or an alloy comprising metallic lithium.

According to an example of interest, the negative electrode comprises metallic lithium.

According to another embodiment, the electrolyte is a glass or ceramic electrolyte.

According to another embodiment, the electrolyte is a liquid electrolyte comprising a salt in a solvent.

According to another embodiment, the electrolyte is a gel electrolyte comprising a salt in a solvent and optionally a solvating polymer.

According to another embodiment, the electrolyte is a solid polymer electrolyte comprising a salt in a solvating polymer.

According to one example, the salt is a lithium salt. For example, the lithium salt is selected from the group consisting of lithium hexafluorophosphate (LiPF₆), lithium bis(trifluoromethanesulfonyl)imide (LiTFSI), lithium bis(fluorosulfonyl)imide (LiFSI), lithium 2-trifluoromethyl-4,5-dicyanoimidazolate (LiTDI), lithium 4,5-dicyano-1,2,3-triazolate (LiDCTA), lithium bis(pentafluoroethylsulfonyl)imide (LiBETI), lithium tetrafluoroborate (LiBF₄), lithium bis(oxalato)borate (LiBOB), lithium nitrate (LiNO₃), lithium chloride (LiCI), lithium bromide (LiBr), lithium fluoride (LiF), lithium perchlorate (LiCIO₄), lithium hexafluoroarsenate (LiAsF₆), lithium trifluoromethanesulfonate (LiSO₃CF₃) (LiTf), lithium fluoroalkylphosphate Li[PF₃(CF₂CF₃)₃](LiFAP), lithium tetrakis(trifluoroacetoxy)borate Li[B(OCOCF₃)₄](LiTFAB), lithium bis(1,2-benzenediolato(2-)-O,O′)borate[B(C₆O₂)₂](LiBBB), and a combination of at least two thereof.

According to an example of interest, the lithium salt is lithium hexafluorophosphate (LiPF₆).

According to another aspect, the present technology relates to a battery comprising at least one electrochemical cell as defined herein.

According to one embodiment, said battery is selected from the group consisting of a lithium battery, a lithium-ion battery, a sodium battery, a sodium-ion battery, a potassium battery, a potassium-ion battery, a magnesium battery and a magnesium-ion battery. According to one example, said battery is a lithium battery or a lithium-ion battery.

### BRIEF DESCRIPTION OF THE FIGURES

FIG. 1 is an X-ray diffraction pattern for a tunnel-type sodium, lithium, and manganese oxide powder of formula Na_{0.08}Li_{0.36}MnO₂, as described in Example 1(d).

FIG. 2 is an X-ray diffraction pattern for a tunnel-type sodium, lithium, iron, manganese, and titanium oxide powder of formula Na_{0.10}Li_{0.33}Fe_{0.34}Mn_{0.44}Ti_{0.22}O₂, as described in Example 1(d).

FIG. 3 is an X-ray diffraction pattern for a tunnel-type sodium, lithium, iron, manganese, and titanium oxide powder of formula Na_{0.08}Li_{0.38}Fe_{0.30}Mn_{0.55}Ti_{0.15}O₂, as described in Example 1(d).

FIG. 4 is an X-ray diffraction pattern for a tunnel-type sodium, lithium, iron, manganese, and titanium oxide powder of formula Na_{0.20}Li_{0.24}Fe_{0.34}Mn_{0.55}Ti_{0.11}O₂, as described in Example 1(d).

FIG. 5 is an X-ray diffraction pattern for a tunnel-type sodium, lithium, iron, manganese, and titanium oxide powder of formula Na_{0.21}Li_{0.20}Fe_{0.40}Mn_{0.50}Ti_{0.10}O₂, as described in Example 1(d).

FIG. 6 presents charge and discharge profiles obtained for Cell 1 and recorded in (1) at a cycling rate of 0.1 C between 2.0 V and 4.8 V vs. Li⁺/Li; and in (2) between 2.0 V and 4.6 V vs. Li⁺/Li, as described in Example 2(b). The results are presented for the second discharge and charge cycle.

FIG. 7 presents a charge and discharge profile obtained for Cell 2 and recorded at a cycling rate of 0.1 C between 2.0 V and 4.6 V vs. Li⁺/Li, as described in Example 2(b). The results are presented for the second discharge and charge cycle.

FIG. 8 presents a charge and discharge profile obtained for Cell 3 and recorded at a cycling rate of 0.1 C between 2.0 V and 4.6 V vs. Li⁺/Li, as described in Example 2(b). The results are presented for the second discharge and charge cycle.

FIG. 9 presents charge and discharge profiles obtained for Cell 4 and recorded at a cycling rate of 0.1 C between 2.0 V and 4.8 V vs. Li⁺/Li, as described in Example 2(b). The results are presented for the second (1) and fifth (2) charge/discharge cycles.

FIG. 10 presents charge and discharge profiles obtained for Cell 5 and recorded at a cycling rate of 0.1 C between 2.5 V and 4.8 V vs. Li⁺/Li, as described in Example 2(b). The results are presented for the second charge/discharge cycle.

FIG. 11 presents in (a) charge and discharge profiles recorded at a cycling rate of 0.1 C between 2.0 V and 4.8 V vs. Li⁺/Li; and in (b) a graph representing the capacity as a function of the number of cycles obtained for Cell 6, as described in Example 2(b).

FIG. 12 presents in (a) charge and discharge profiles recorded at a cycling rate of 0.1 C between 2.0 V and 4.8 V vs. Li⁺/Li; and in (b) a graph representing the capacity as a function of the number of cycles obtained for Cell 7, as described in Example 2(b).

### DETAILED DESCRIPTION

All technical and scientific terms and expressions used herein have the same definitions as those commonly understood by the person skilled in the art of the present technology. The definition of some terms and expressions used is nevertheless provided below.

When the term “about” is used herein, it means approximately, in the region of, or around. For example, when the term “about” is used in connection with a numerical value, it modifies it above and below by a variation of 10% compared to the nominal value. This term can also take into account, for instance, the experimental error of a measuring device or rounding.

When an interval of values is mentioned in the present application, the lower and upper limits of the interval are, unless otherwise specified, always included in the definition. When an interval of values is mentioned in the present application, then all intermediate intervals and sub-intervals, as well as the individual values included in the intervals of values, are also included in the definition.

When the article “a” is used to introduce an element in the present application, it does not have the meaning of “only one”, but rather of “one or more”. Of course, where the description states that a particular step, component, element or feature “may” or “could” be included, that particular step, component, element or feature is not required to be included in each embodiment.

The present technology generally relates to electrochemically active materials, their manufacturing processes and their use in electrochemical cells. More particularly, the present technology concerns an electrochemically active material comprising a lithium-substituted iron-doped tunnel-type oxide of sodium, manganese, and at least one metallic element.

According to one example, the metallic element of the lithium-substituted iron-doped tunnel-type oxide of sodium, manganese, and at least one metallic element may be a transition metal, a post-transition metal, a metalloid, an alkali metal other than lithium or sodium, an alkaline earth metal, or a combination thereof, when compatible. For example, the metal may be a transition or post-transition metal selected from the group consisting of manganese (Mn), titanium (Ti), vanadium (V), nickel (Ni), cobalt (Co), chromium (Cr), molybdenum (Mo), zirconium (Zr), tin (Sn), ruthenium (Ru), and other similar metallic elements, or a combination thereof, when compatible.

According to another example, the electrochemically active material comprises a lithium-substituted iron-doped tunnel-type oxide of sodium, manganese, and at least one metallic element of formula NaₐLi_{b}Fe_{c}Mn_{d}MeO₂, wherein a is a number such that 0<a<0.22; b is a number such that 0.18<b<0.40 and such that a+b is 0.38<a+b<0.62; c is a number such that 0<c<0.40; d is a number such that 0.44≤d<1; e is a number such that c+d+e=1; and M is selected from the group consisting of manganese (Mn), titanium (Ti), vanadium (V), nickel (Ni), cobalt (Co), chromium (Cr), molybdenum (Mo), zirconium (Zr), tin (Sn), ruthenium (Ru), and other similar metallic elements, or a combination thereof, when compatible.

It is understood that, when the metallic element (M) is manganese (Mn), the lithium-substituted iron-doped tunnel-type oxide of sodium, manganese, and at least one metallic element includes manganese with at least two different oxidation states.

According to some examples, the metallic element (M) is a transition metal selected from the group consisting of manganese (Mn), titanium (Ti), vanadium (V), nickel (Ni), cobalt (Co), chromium (Cr), molybdenum (Mo), zirconium (Zr), ruthenium (Ru), and other similar transition metals, or a combination thereof, when compatible. According to some examples of interest, the metallic element is titanium (Ti).

According to some examples, a is a number such that 0.01<a<0.22, or 0.02<a<0.22, or 0.03<a<0.22, or 0.04<a<0.22, or 0.05<a<0.22, or 0.06<a<0.22, or 0.07<a<0.22, or 0.08<a s 0.21. According to some examples of interest, a is a number such that 0.08 s a s 0.21.

According to some examples, b is a number such that a+b is 0.38<a+b<0.61, or 0.38<a+b<0.60, or 0.38<a+b<0.59, or 0.38<a+b<0.58, or 0.38<a+b<0.57, or 0.38<a+b<0.56, or 0.38<a+b<0.55, or 0.38<a+b<0.54, or 0.38<a+b<0.53, or 0.38<a+b<0.52, or 0.38<a+b<0.51, or 0.38<a+b<0.50, or 0.38<a+b<0.49, or 0.38<a+b<0.48, or 0.38<a+b<0.47, or 0.39<a+b<0.47, or 0.40<a+b<0.47. According to some examples of interest, b is a number such that a+b is 0.40<a+b<0.47. For example, b may be a number such that 0.19<b<0.40, or 0.20 s b<0.40, or 0.20 s b<0.39, or 0.20 s b s 0.38. According to some examples of interest, b is a number such that 0.20 s b s 0.38.

According to some examples, c is a number such that 0.05<c≤0.40, or 0.10<c≤0.40, or 0.15<c≤0.40, or 0.20<c≤0.40, or 0.25<c≤0.40, or 0.30 s c s 0.40. According to some examples of interest, c is a number such that 0.30 s c s 0.40.

According to some examples, d is a number such that 0.44≤d<1, or 0.44≤d<0.95, or 0.44 s d<0.90, or 0.44<≤d<0.85, or 0.44<≤d<0.80, or 0.44<≤d<0.75, or 0.44<≤d<0.70, or 0.44<d<0.65, or 0.44≤d<0.60, or 0.44≤d≤0.55. According to some examples of interest, d is a number such that 0.44≤d≤0.55.

Non-limiting examples of lithium-substituted iron-doped tunnel-type oxides of sodium, manganese, and at least one metallic element include Na_{0.10}Li_{0.33}Fe_{0.34}Mn_{0.44}Ti_{0.22}O₂, Na_{0.08}Li_{0.38}Fe_{0.30}Mn_{0.55}Ti_{0.15}02, Na_{0.20}Li_{0.24}Fe_{0.34}Mn_{0.55}Ti_{0.11}O₂, Na_{0.21}Li_{0.20}Fe_{0.4}0Mn_{0.50}Ti_{0.10}O₂, Na_{0.10}Li_{0.40}Fe_{0.08}Mn_{0.81}Ti_{0.10}O₂, and Na_{0.10}Li_{0.4}0Fe_{0.11}Mn_{0.78}Ti_{0.11}O₂.

According to another example, the electrochemically active material can further include at least one doping element that can be included in smaller amounts, for example, to modulate or optimize its electrochemical properties. For example, the electrochemically active material may be doped by the partial substitution of the metallic element by at least one other element. For example, the electrochemically active material can be slightly doped with at least one doping element selected from a transition metal (for example, iron (Fe), cobalt (Co), nickel (Ni), manganese (Mn), titanium (Ti), chromium (Cr), copper (Cu), vanadium (V), zinc (Zn), and/or yttrium (Y)), a post-transition metal (for example, Al), an alkaline earth metal (for example, Mg), and/or a metalloid (for example, Sb).

According to another example, the electrochemically active material may be in the form of particles (for example, microparticles or nanoparticles) which may be freshly formed and may additionally include a coating material. The coating material can be an electronically conductive material, for example, a carbon coating.

For example, the partial substitution of sodium ions by lithium ions can significantly improve the electrochemical performance of an electrochemical cell comprising the present electrochemically active material.

According to some examples, the partial substitution of sodium ions by lithium ions in the lithium-substituted iron-doped tunnel-type oxide of sodium, manganese, and at least one metallic element can substantially improve the electrochemical properties of the electrochemically active material.

Without wishing to be bound by theory, the partial substitution of sodium ions by lithium ions can stabilize the structure of the electrochemically active material based on iron-doped tunnel-type oxide of sodium, manganese, and at least one metallic element and, consequently, substantially improve its electrochemical performance. For example, the electrochemical properties of the electrochemically active material can be modulated by varying the degree of lithium substitution.

According to some examples, doping lithium-substituted tunnel-type oxides of sodium, manganese, and at least one metallic element with iron ions can also substantially improve the electrochemical properties of the electrochemically active material. For example, the partial substitution of manganese with iron ions can significantly increase the average operating voltage of the electrochemically active material. For example, the electrochemical properties of the electrochemically active material can be modulated by varying the degree of iron substitution.

According to some examples, cationic doping of the lithium-substituted iron-doped tunnel-type oxide of sodium, manganese, and at least one metallic element by a transition metal or post-transition metal such as those described above can also substantially improve the electrochemical properties of the electrochemically active material. For example, the partial substitution of manganese by titanium can substantially improve the electrochemical properties of the electrochemically active material. For example, the electrochemical properties of the electrochemically active material can be modulated by varying the composition of said transition metal or said post-transition metal in the lithium-substituted iron-doped tunnel-type oxide of sodium, manganese, and at least one metallic element.

The present technology also relates to a process for manufacturing the electrochemically active material as defined herein, the process including the following steps:
(i) preparation of an iron-doped tunnel-type oxide of sodium, manganese, and at least one metallic element; and
(ii) partial substitution of the sodium ions of the iron-doped tunnel-type oxide of sodium, manganese, and at least one metallic element by lithium ions to obtain the electrochemically active material.

According to one example, the iron-doped tunnel-type oxide of sodium, manganese, and at least one metallic element prepared in step (i) is of formula NaₐFe_{c}Mn_{d}MeO₂, wherein a is a number such that 0.38<a<0.62; c is a number such that 0<c<0.40; d is a number such that 0.44≤d<1; e is a number such that c+d+e=1; and M is selected from the group consisting of manganese (Mn), titanium (Ti), vanadium (V), nickel (Ni), cobalt (Co), chromium (Cr), molybdenum (Mo), zirconium (Zr), tin (Sn), ruthenium (Ru), and other similar metals, or a combination thereof, when compatible.

According to some examples, the metallic element (M) is a transition metal selected from the group consisting of manganese (Mn), titanium (Ti), vanadium (V), nickel (Ni), cobalt (Co), chromium (Cr), molybdenum (Mo), zirconium (Zr), ruthenium (Ru), and other similar transition metals, or a combination thereof, when compatible. According to some examples of interest, the metallic element is titanium (Ti).

According to some examples, a is a number such that 0.38<a<0.62, or 0.38<a<0.60, or 0.38<a<0.58, or 0.38<a<0.56, or 0.38<a<0.54, or 0.38<a<0.52, or 0.38<a<0.50, or 0.38<a<0.48, or 0.38<a s 0.46, or 0.40<a s 0.46, or 0.41 s a s 0.46. According to some examples of interest, a is a number such that 0.41 s a s 0.46.

Non-limiting examples of iron-doped tunnel-type oxides of sodium, manganese, and at least one metallic element include Na_{0.44}Fe_{0.34}Mn_{0.44}Ti_{0.22}O₂, Na_{0.43}Fe_{0.34}Mn_{0.44}Ti_{0.22}O₂, Na_{0.44}Fe_{0.30}Mn_{0.55}Ti_{0.15}O₂, Na_{0.46}Fe_{0.30}Mn_{0.55}Ti_{0.15}O₂, Na_{0.44}Fe_{0.34}Mn_{0.55}Ti_{0.11}O₂, Na_{0.44}Fe_{0.40}Mn_{0.50}Ti_{0.10}O₂, Na_{0.41}Fe_{0.4}0Mn_{0.50}Ti_{0.10}O₂, Na_{0.50}Fe_{0.08}Mn_{0.81}Ti_{0.1}O₂, and Na_{0.50}Fe_{0.11}Mn_{0.78}Ti_{0.11}O₂.

According to one example, the iron-doped tunnel-type oxide of sodium, manganese, and at least one metallic element can be prepared by a solid-state synthesis technique or by a wet synthesis technique. For example, the wet synthesis technique can be a sol-gel process.

According to some examples, the iron-doped tunnel-type oxide of sodium, manganese, and at least one metallic element can be prepared via a solid-state synthesis process. The solid-state synthesis process may involve mixing and grinding appropriate precursors (metal oxides or metal carbonates) in selected amounts to obtain an iron-doped tunnel-type oxide of sodium, manganese, and at least one metallic element having a desired stoichiometry. The mixing and grinding steps can be carried out sequentially, simultaneously, or partially overlapping in time with each other.

According to some examples, the mixing and grinding steps are carried out simultaneously. All compatible mixing and grinding methods are contemplated. For example, solid precursors can be mixed and ground manually or by any compatible mechanical method, such as mechanical grinding. The solid-state synthesis process can also involve heating the mixed and ground precursors to obtain the desired iron-doped tunnel-type oxide of sodium, manganese, and at least one metallic element. The heating step can be carried out at a temperature and for a duration sufficient to obtain the powder of iron-doped tunnel-type oxide of sodium, manganese, and at least one metallic element. The heating step can be carried out, for example, in a furnace at a temperature of between about 800° C. and about 1000° C., limits included. The heating step can be carried out, for example, over a period in the range of from about 3 hours to about 24 hours, upper and lower limits included. The heating step can be carried out under any suitable conditions in order to obtain the desired powder of iron-doped tunnel-type oxide of sodium, manganese, and at least one metallic element. For example, the heating step can be carried out under an air or oxygen atmosphere, but any other compatible atmosphere is contemplated.

According to some examples, the iron-doped tunnel-type oxide of sodium, manganese, and at least one metallic element can be prepared via a wet chemical synthesis process, such as a sol-gel process. The sol-gel process can be carried out in an aqueous medium using inorganic salt precursors and a chelating agent. For example, the inorganic salt precursors may be metal carbonate, acetate, oxalate or alkoxide precursors, and the chelating agent may be an organic acid such as citric acid. The sol-gel process may consist of dissolving an appropriate quantity of inorganic salt precursors in water and a (Na+Mn):chelating agent in a molar ratio of about 10. For example, the dissolution step can be carried out with stirring. The solution thus obtained can then be heated with stirring to a temperature and for a duration sufficient to form the sol-gel precursors. For example, the solution can then be heated to a temperature of about 80° C. until the sol-gel precursors are formed. The sol-gel precursors thus obtained can then be calcined at a temperature and for a duration sufficient to decompose the organic and inorganic contents. For example, the sol-gel precursors can then be calcined in a furnace at a temperature of about 400° C. for about 6 hours. The powders thus obtained can then be ground and calcined at a temperature and for a time sufficient to obtain the desired powder of iron-doped tunnel-type oxide of sodium, manganese, and at least one metallic element. For example, the calcination step can be carried out in a furnace at a temperature of about 900° C. for about 9 hours. The calcination step can be carried out under any suitable conditions in order to obtain the desired powder of iron-doped tunnel-type oxide of sodium, manganese, and at least one metallic element. For example, the calcination step can be carried out under an air or oxygen atmosphere, but any other compatible atmosphere is contemplated.

According to some examples, the partial substitution of sodium ions by lithium ions can be carried out via a one-stage or two-stage ion exchange process. The ion exchange reaction can be carried out by mixing the powder of iron-doped tunnel-type oxide of sodium, manganese, and at least one metallic element prepared in step (i) with an excess amount of a lithium salt or lithium salt composition. The lithium salt composition may be a mixture of lithium nitrate (LiNO₃) and lithium chloride (LiCI) or lithium hydroxide (LiOH), for example in a LiNO₃:LiCI or LiOH molar ratio of about 2:1. For example, the powder prepared in step (i) can be mixed with up to a 20-fold molar excess of a lithium salt or lithium salt composition. The mixture can then be heated at a temperature and for a duration sufficient to obtain the electrochemically active material, namely a lithium-substituted iron-doped tunnel-type oxide of sodium, manganese, and at least one metallic element of a desired stoichiometry. For example, the mixture can be heated to a temperature of between about 240° C. and about 400° C., either once for about 4 hours to about 15 hours, or twice for about 2 hours to about 10 hours.

The present technology also relates to electrode materials comprising the electrochemically active material as defined herein or an electrochemically active material prepared by the process as defined herein.

According to one example, the electrode material as herein defined may further include an electronically conductive material. Non-limiting examples of electronically conductive materials include a carbon source such as carbon black (for example, Ketjen™ carbon and Super P™ carbon), acetylene black (for example, Shawinigan carbon and Denka™ carbon black), graphite, graphene, carbon fibers (for example, vapor grown carbon fibers (VGCFs)), carbon nanofibers, carbon nanotubes (CNTs), and a combination of at least two thereof. According to a variant of interest, the electronically conductive material is selected from Ketjen™ carbon, Super P™ carbon, VGCFs, and a combination of at least two thereof. According to an example of interest, the electronically conductive material is a mixture of VGCFs and carbon black.

According to another example, the electrode material as defined herein may further include a binder. For example, the binder may be selected for its compatibility with the various elements of an electrochemical cell. Any known compatible binder is contemplated. For example, the binder may be a polymeric binder of the polyether type, a fluorinated polymer, and a water-soluble binder. According to one example, the binder is a fluorinated polymer such as polyvinylidene fluoride (PVDF) and polytetrafluoroethylene (PTFE). According to another example, the binder is a water-soluble binder such as styrene-butadiene rubber (SBR), acrylonitrile-butadiene rubber (NBR), hydrogenated NBR(HNBR), epichlorohydrin rubber (CHR), or acrylate rubber (ACM), optionally comprising a thickening agent such as carboxymethyl cellulose (CMC), or an acidic polymer such as polyacrylic acid (PAA), poly(methyl methacrylate) (PMMA), or a combination thereof. According to another example, the binder is an optionally cross-linked polymeric binder of the polyether type. For example, the polymeric binder of the polyether type binder is linear, branched, and/or cross-linked and is based on poly(ethylene oxide) (PEO), poly(propylene oxide) (PPO), or a combination of the two (or as an EO/PO copolymer), and optionally includes cross-linkable units. According to a variant of interest, the binder is polyvinylidene fluoride (PVDF).

According to another example, the electrode material as defined herein may further optionally include at least one additional additive such as ionic conductors, inorganic particles, glass or ceramic particles, nanoceramics (for example, aluminum oxide (Al₂O₃), titanium dioxide (TiO₂), silicon dioxide (SiO₂), and other similar compounds), salts (for example, lithium salts), and other similar additives. For example, the additional additive can be an ionic conductor selected from the group consisting of NASICON, LISICON, thio-LiSICON, garnets, sulfides, sulfur halides, phosphates, thio-phosphates, in crystalline and/or amorphous form, and a combination of at least two thereof.

According to another aspect, the present technology relates to an electrode comprising the electrode material as defined herein on a current collector (for example, an aluminum or a copper foil). The electrode can also be a self-supported electrode. According to an example of interest, the electrode is a positive electrode.

According to another aspect, the present technology relates to an electrochemical cell comprising a negative electrode, a positive electrode, and an electrolyte, wherein the positive electrode is as defined herein.

According to one example, the negative electrode (counter-electrode) includes an electrochemically active material selected from all known compatible electrochemically active materials. For example, the electrochemically active material of the negative electrode can be selected for its electrochemical compatibility with the various elements of the electrochemical cell as defined herein. Non-limiting examples of electrochemically active negative electrode materials include alkali metals, alkali metal alloys, and prelithiated electrochemically active materials.

According to an example of interest, the electrochemically active material of the negative electrode can be a metallic lithium film or an alloy including metallic lithium.

According to another example, the electrolyte can be selected for its compatibility with the various elements of the electrochemical cell. Any type of compatible electrolyte is contemplated. For example, the electrolyte may be a liquid electrolyte comprising a salt in a solvent. The electrolyte can also be a gel electrolyte comprising a salt in a solvent and optionally a solvating polymer. The electrolyte can also be a solid polymer electrolyte comprising a salt in a solvating polymer. The electrolyte can also be a glass or ceramic electrolyte.

The salt, if present in the electrolyte, can be an ionic salt, such as a lithium salt. Non-limiting examples of lithium salts include lithium hexafluorophosphate (LiPF₆), lithium bis(trifluoromethanesulfonyl)imide (LiTFSI), lithium bis(fluorosulfonyl)imide (LiFSI), lithium 2-trifluoromethyl-4,5-dicyanoimidazolate (LiTDI), lithium 4,5-dicyano-1,2,3-triazolate (LiDCTA), lithium bis(pentafluoroethylsulfonyl)imide (LiBETI), lithium tetrafluoroborate (LiBF₄), lithium bis(oxalato)borate (LiBOB), lithium nitrate (LiNO₃), lithium chloride (LiCI), lithium bromide (LiBr), lithium fluoride (LiF), lithium perchlorate (LiCIO₄), lithium hexafluoroarsenate (LiAsF₆), lithium trifluoromethanesulfonate (LiSO₃CF₃) (LiTf), lithium fluoroalkylphosphate Li[PF₃(CF₂CF₃)₃](LiFAP), lithium tetrakis(trifluoroacetoxy)borate Li[B(OCOCF₃)₄](LiTFAB), lithium bis(1,2-benzenediolato(2-)-O,O′)borate[B(C₆O₂)₂](LiBBB), and a combination of at least two thereof. According to an example of interest, the lithium salt is lithium hexafluorophosphate (LiPF₆).

The solvent, if present in the electrolyte, is preferably a non-aqueous solvent. Non-limiting examples of non-aqueous solvents include cyclic carbonates such as ethylene carbonate (EC), propylene carbonate (PC), butylene carbonate (BC), and vinylene carbonate (VC); acyclic carbonates such as dimethyl carbonate (DMC), diethyl carbonate (DEC), ethyl methyl carbonate (EMC), and dipropyl carbonate (DPC); lactones such as γ-butyrolactone (γ-BL) and γ-valerolactone (γ-VL); acyclic ethers such as 1,2-dimethoxyethane (DME), 1,2-diethoxyethane (DEE), ethoxy methoxy ethane (EME), trimethoxymethane, tetraethylene glycol dimethyl ether or tetraglyme (TEGDME), and ethylmonoglyme; cyclic ethers such as tetrahydrofuran, 2-methyltetrahydrofuran, 1,3-dioxolane, and dioxolane derivatives; and other solvents such as dimethylsulfoxide, formamide, acetamide, dimethylformamide, acetonitrile, propylnitrile, nitromethane, phosphoric acid triesters, sulfolane, methylsulfolane, propylene carbonate derivatives, and mixtures thereof. According to some examples of interest, the non-aqueous solvent is a mixture of at least two carbonates, for example, a mixture of ethylene carbonate and ethyl methyl carbonate (EC/EMC). According to an example of interest, the electrolyte is a liquid electrolyte and comprises LiPF₆ in an EC/EMC mixture ([3:7] by volume) with 5% fluoroethylene carbonate (FEC).

According to some examples, the electrolyte is a liquid electrolyte, and the electrode material comprises an electrochemically active material as defined herein or an electrochemically active material prepared by the process as defined herein, PVDF as a binder and an electronically conductive material selected from the group consisting of Ketjen™ carbon, Super P™ carbon, and VGCFs.

According to some examples, the electrolyte is a gel electrolyte or a gel polymer electrolyte. The gel polymer electrolyte may comprise, for example, a polymer precursor, a salt (for example, a salt as previously defined), a solvent (for example, a solvent as previously defined), and a polymerization and/or cross-linking initiator, if necessary. Non-limiting examples of gel electrolytes include, without limitation, the gel electrolytes described in PCT patent application published under numbers WO2009/111860 (Zaghib et al.) and WO2004/068610 (Zaghib et al.).

According to some examples, a liquid electrolyte or gel electrolyte as previously defined can also impregnate a separator. Examples of separators include, but are not limited to, separators such as Whatman™ glass fiber GF filters.

According to some examples, the electrolyte is a solid polymer electrolyte including a salt in a solvent polymer. For example, the solid polymer electrolyte may be selected from all known solid polymer electrolytes and may be selected for its compatibility with the various elements of the electrochemical cell. For example, the solid polymer electrolyte is selected for its compatibility with lithium. Solid polymer electrolytes can generally include one or more solid polar polymer(s), optionally cross-linked, and a salt (for example, a salt as previously defined). Polyether-type polymers can be used, such as those based on PEO, but several other compatible polymers are also known for the preparation of solid polymer electrolytes and are also contemplated. The polymer can be cross-linked. Examples of such polymers include branched polymers, for example, star polymers or comb polymers such as those described in the U.S. patent published under number 7,897,674 B2 (Zaghib et al.) (US'674).

According to some examples, the solid polymer electrolyte may include a block copolymer composed of at least one lithium-ion solvating segment and optionally at least one cross-linkable segment. Preferably, the lithium-ion solvation segment is selected from homo- or copolymers having repeating units of Formula 1:

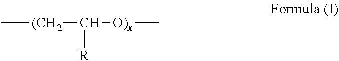

wherein,
R is selected from a hydrogen atom, a C₁-C₁₀alkyl group or a —(CH₂—O—R^{a}R^{b}) group;
R^{a} is (CH₂—CH₂—O)_{y};
R^{b} is selected from a hydrogen atom and a C₁-C₁₀alkyl group;
x is an integer selected from the range of 10 to 200,000; and
y is an integer selected from the range of 0 to 10.

According to another example, the cross-linkable segment can be a polymer segment comprising at least one functional group that is cross-linkable in a multi-dimensionally by irradiation or heat treatment.

According to some examples, the electrolyte is a solid polymer electrolyte including LiPF₆ and a PEO-based solvating polymer. According to some examples, the electrolyte is a solid polymer electrolyte as previously defined and the electrode material comprises an electrochemically active material as defined herein or an electrochemically active material prepared by the process as defined herein and an electronically conductive material selected from the group consisting of Ketjen™ carbon, Super P™ carbon, and VGCFs.

In examples where the electrolyte is a solid polymer electrolyte, the electrode material may, for example, include from about 80 wt. % to about 90 wt. % of the electrochemically active material, from about 1 wt. % to about 5 wt. % of the electronically conductive material and from about 5 wt. % to about 19 wt. % of the solid polymer electrolyte.

According to some examples, the electrolyte is a glass or ceramic electrolyte. For example, the glass or ceramic electrolyte may include a crystalline ion-conductive ceramic or an amorphous ion-conductive ceramic, an amorphous ion-conductive glass, or an ion-conductive glass-ceramic. Non-limiting examples of glass or ceramic electrolytes include site-deficient perovskite-type electrolytes, garnet-type electrolytes, NASICON-type glass-ceramic electrolytes, LISICON-type electrolytes, lithium-stabilized sodium ion (Na⁺) conducting aluminum oxides (Al₂O₃), and other similar glass or ceramic electrolytes.

According to some examples, the electrolyte may also optionally include at least one additional additive, such as ionically conductive materials, inorganic particles, glass or ceramic particles, for example, nanoceramics (for example, aluminum oxide (Al₂O₃), titanium dioxide (TiO₂), silicon dioxide (SiO₂), and similar compounds), and other such additives. For example, the additional additive may be selected from NASICON, LISICON, thio-LISICON, garnets, sulfides, sulfur halides, phosphates, thio-phosphates, in crystalline and/or amorphous form, and combinations thereof. According to one example, the additional additive can be substantially dispersed in the electrolyte. The additional additive may also be present in a separate layer.

The present technology also relates to a battery comprising at least one electrochemical cell as defined herein. For example, the battery may be a lithium battery or a lithium-ion battery, a sodium battery or a sodium-ion battery, a magnesium battery or a magnesium-ion battery, or a potassium battery or a potassium-ion battery. According to a variant of interest, the battery is a lithium battery or a lithium-ion battery. According to another variant of interest, the battery is a sodium battery or a sodium-ion battery.

### EXAMPLES

The following examples are for illustrative purposes only and should not be interpreted as further limiting the scope of the invention as contemplated. These examples will be better understood by referring to the accompanying Figures.

Unless otherwise specified, all numbers expressing component quantities, preparation conditions, concentrations, properties, etc. used herein are to be understood as modified in all cases by the term “about”. At a minimum, each numerical parameter should be interpreted in the light of the number of significant numbers reported and by applying common rounding techniques. Therefore, unless otherwise specified, the numerical parameters set out in this specification are approximations which may vary according to the desired properties. Notwithstanding the fact that the ranges of numerical values and the parameters defining the scope of the embodiments are approximations, the numerical values presented in the following examples are reported as accurately as possible. However, any numerical value intrinsically contains some errors resulting from variations in experiments, test measurements, statistical analyses, etc.

### Example 1: Electrochemically Active Material Synthesis

### a) Solid-State Synthesis of Iron-Doped Tunnel-Type Oxides of Sodium, Manganese, and at Least One Metallic Element

Iron-doped tunnel-type oxides of sodium, manganese, and at least one metallic element of formulae Na_{0.44}Mn_{0.55}Ti_{0.10}O₂, Na_{0.43}Fe_{0.34}Mn_{0.44}Ti_{0.22}O₂, Na_{0.46}Fe_{0.30}Mn_{0.55}Ti_{0.15}O₂, Na_{0.44}Fe_{0.34}Mn_{0.55}Ti_{0.11}O₂, Na_{0.41}Fe_{0.4}0Mn_{0.50}Ti_{0.10}O₂, Na_{0.50}Fe_{0.08}Mn_{0.81}Ti_{0.1}O₂, and Na_{0.50}Fe_{0.11}Mn_{0.78}Ti_{0.11}O₂ were synthesized by a simple solid-state reaction. The respective precursors, sodium carbonate (Na₂CO₃), manganese(II) oxide (Mn₂O₃), iron(Ill) oxide (Fe₂O₃), and titanium dioxide (TiO₂) were weighed to obtain the desired stoichiometries. Samples were prepared by grinding and mixing the precursor powders. The ground and mixed precursor powders were then placed in a furnace and heated to a temperature between about 700° C. and about 1000° C. under an air or oxygen atmosphere for 2 to 24 hours.

### b) Wet Chemical Synthesis of Iron-Doped Tunnel-Type Oxides of Sodium, Manganese, and at Least One Metallic Element

Alternatively, iron-doped tunnel-type oxides of sodium, manganese, and at least one metallic element of formulae Na_{0.44}Mn_{0.55}Ti_{0.10}O₂, Na_{0.43}Fe_{0.34}Mn_{0.44}Ti_{0.22}O₂, Na_{0.46}Fe_{0.30}Mn_{0.55}Ti_{0.15}O₂, Na_{0.44}Fe_{0.34}Mn_{0.55}Ti_{0.11}O₂, Na_{0.41}Fe_{0.40}Mn_{0.50}Ti_{0.10}O₂, Na_{0.50}Fe_{0.08}Mn_{0.81}Ti_{0.11}O₂, and Na_{0.50}Fe_{0.11}Mn_{0.78}Ti_{0.11}O₂ were also prepared using a sol-gel process. Sol-gel powders were synthesized using citric acid (C₆H₈O₇) as a chelating agent. The respective precursors, sodium carbonate (Na₂CO₃), manganese(II) acetate ((CH₃CO₂)₂Mn), iron(II) oxalate, and titanium tetrabutoxide (C₁₆H₃₆O₄Ti) (all from Sigma-Aldrich, >99.99%), were weighed to obtain the desired stoichiometry and dissolved in distilled water under magnetic stirring with C₆H₈O₇ in a molar ratio (Na⁺Mn)/C₆H₈O₇=10. The solutions thus obtained were then heated to a temperature of about 80° C., with stirring, until transparent sol-gel precursors were obtained.

The sol-gel precursors thus obtained were then calcined in a furnace at a temperature of about 400° C. for about 6 hours to decompose the organic and inorganic contents (including anionic salts and C₆H₈O₇).

Finally, the powders thus obtained were ground in a mortar and calcined in a furnace at a temperature of about 900° C. for about 9 hours in an air or oxygen atmosphere to obtain the final sol-gel powders Na_{0.44}Mn_{0.55}Ti_{0.10}O₂, Na_{0.43}Fe_{0.34}Mn_{0.44}Ti_{0.22}O₂, Na_{0.46}Fe_{0.30}Mn_{0.55}Ti_{0.15}O₂, Na_{0.44}Fe_{0.34}Mn_{0.55}Ti_{0.11}O₂, Na_{0.41}Fe_{0.40}Mn_{0.50}Ti₀0.1002, Na_{0.50}Fe_{0.08}Mn_{0.81}Ti_{0.11}O₂, and Na_{0.50}Fe_{0.11}Mn_{0.78}Ti_{0.11}O₂.

### c) Synthesis of Iron-Doped Tunnel-Type Oxides of Sodium, Lithium, Manganese, and at Least One Metallic Element

Iron-doped tunnel-type oxides of sodium, lithium, manganese, and at least one metallic element of formulae Na_{0.10}Li_{0.33}Fe_{0.34}Mn_{0.44}Ti_{0.22}O₂, Na_{0.08}Li_{0.38}Fe_{0.30}Mn_{0.55}Ti_{0.15}O₂, Na_{0.20}Li_{0.24}Fe_{0.34}Mn_{0.55}Ti_{0.11}O₂, Na_{0.21}Li_{0.20}Fe_{0.40}Mn_{0.50}Ti_{0.1}0O₂, Na_{0.10}Li_{0.40}Fe_{0.08}Mn_{0.81}Ti_{0.11}O₂, and Na_{0.10}Li_{0.40}Fe_{0.11}Mn_{0.78}Ti_{0.11}O₂ were prepared using a one- or two-step ion exchange process to partially replace sodium ions with lithium ions.

The ion exchange reaction was carried out by mixing the powders prepared in Examples 1(a) and 1(b) to a 20-fold molar excess of a lithium eutectic salt composition of lithium nitrate (LiNO₃) and lithium chloride (LiCI) or lithium hydroxide (LiOH) (LiNO₃:LiCl or LiOH=1:1 molar ratio). The mixture was then heated to a temperature of between about 120° C. and about 400° C., either once for about 0.5 hours to about 10 hours, or twice for about 0.25 hours to about 5 hours, to obtain the desired stoichiometry.

Finally, a tunnel-type oxide of sodium, lithium, manganese and at least one metallic element of formula Na_{0.08}Li_{0.36}MnO₂ was also prepared for comparison purposes. This material was obtained by the ion exchange reaction of the present example using a tunnel-type sodium and manganese oxide of formula Na_{0.44}MnO₂ as described in PCT patent application published under number WO2021/195778 (Wang et al.).

### d) X-Ray Diffraction (XRD) on Powders

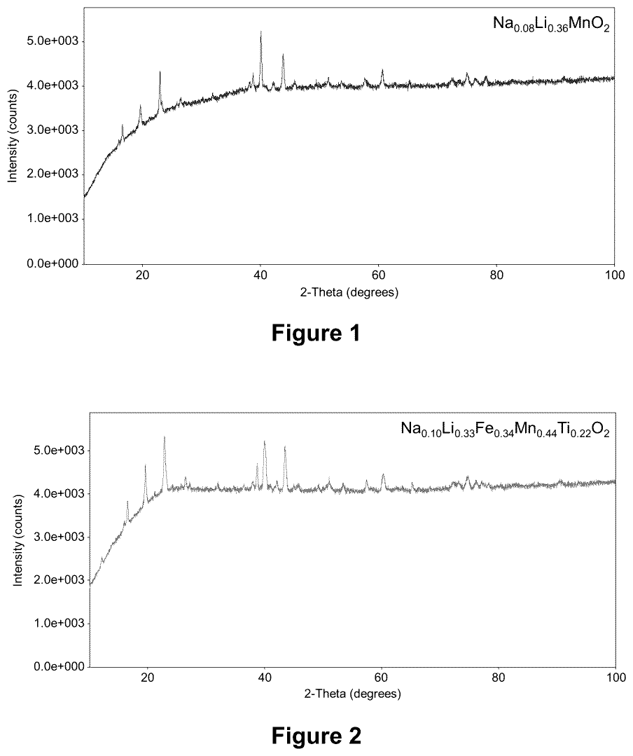

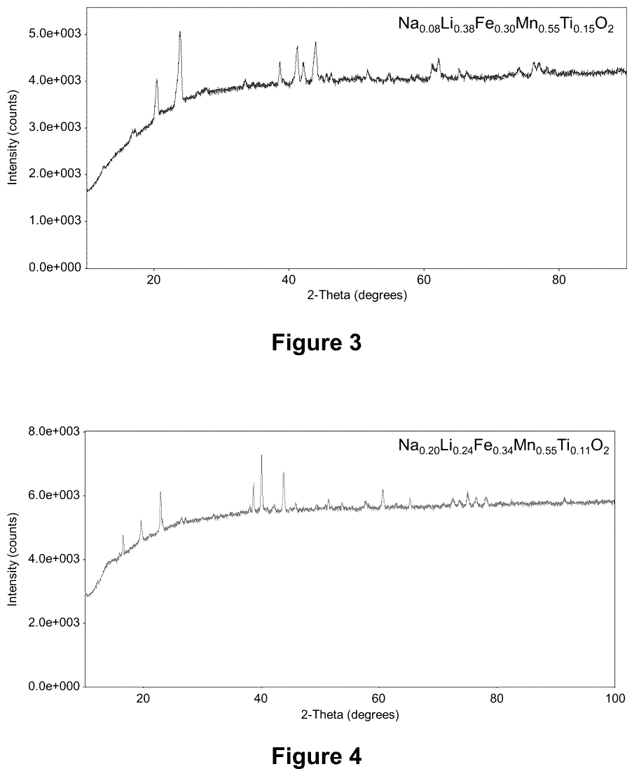

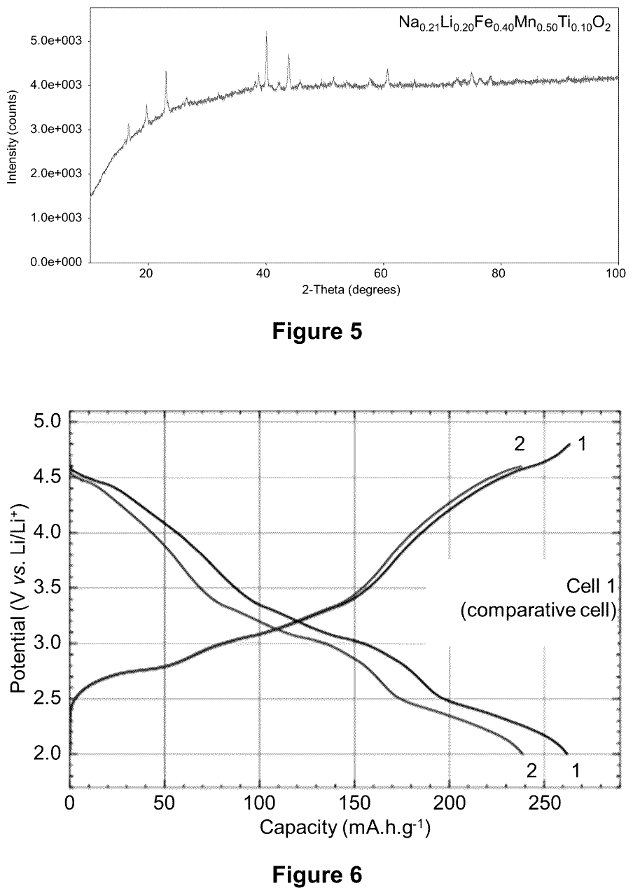

The atomic and molecular structure of the electrochemically active materials was studied by X-ray diffraction carried out on powders of iron-doped tunnel-type oxides of sodium, lithium, manganese, and at least one metallic element, as prepared in Example 1(c). FIGS. 1 to 5 show X-ray diffraction patterns respectively for tunnel-type Na_{0.08}Li_{0.36}MnO₂, Na_{0.10}Li_{0.33}Fe_{0.34}Mn_{0.44}Ti_{0.22}O₂, Na_{0.08}Li_{0.38}Fe_{0.30}Mn_{0.55}Ti_{0.15}O₂, Na_{0.20}Li_{0.24}Fe_{0.34}Mn_{0.55}Ti_{0.11}O₂, and Na_{0.21}Li_{0.20}Fe_{0.40}Mn_{0.50}Ti_{0.10}O₂ powders.

### Example 2: Electrochemical Properties

a) Electrochemical Cell Configurations The electrochemical properties of the electrochemically active materials prepared in Example 1(c) were investigated. All cells were assembled in 2032 type coin cell cases with the components indicated in Table 1 and negative electrodes comprising a metallic lithium film on aluminum current collectors. All cells were assembled with Whatman™ glass fiber GF paper filters separators impregnated with a 1 M solution of LiPF₆ in a non-aqueous solvent mixture of EC/EMC ([3:7] by volume) and 5% FEC as a liquid electrolyte. The electronically conductive material was a mixture of Ketjen™ carbon and Super P™ carbon ([1:1] by weight).

TABLE 1
Electrochemical cell configurations

| | Positive electrode material composition | | | | |
|---|---|---|---|---|---|
| | | Electronically | | | |
| | | conductive | | | Negative |
| Cell | Electrochemically active material | material | Binder | Electrolyte | electrode |
| Cell 1 | Na_{0.08}Li_{0.36}MnO₂ | 10 wt. % | PVDF | LiPF₆/ | Metallic |
| (comparative cell) | (85 wt. %) | | (5 wt. %) | EC:EMC | lithium |
| Cell 2 | Na_{0.10}Li_{0.33}Fe_{0.34}Mn_{0.44}Ti_{0.22}O₂ | | | ([3:7] by | |
| | (85 wt. %) | | | volume) + 5 | |
| Cell 3 | Na_{0.08}Li_{0.38}Fe_{0.30}Mn_{0.55}Ti_{0.15}O₂ | | | wt. % FEC | |
| | (85 wt. %) | | | | |
| Cell 4 | Na_{0.20}Li_{0.24}Fe_{0.34}Mn_{0.55}Ti_{0.11}O₂ | | | | |
| | (85 wt. %) | | | | |
| Cell 5 | Na_{0.21} Li_{0.20}Fe_{0.40}Mn_{0.50}Ti_{0.10}O₂ | | | | |
| | (85 wt. %) | | | | |
| Cell 6 | Na_{0.10}Li_{0.40}Fe_{0.08}Mn_{0.81}Ti_{0.11}O₂ | | | | |
| | (85 wt. %) | | | | |
| Cell 7 | Na_{0.10}Li_{0.40}Fe_{0.11}Mn_{0.78}Ti_{0.11}O₂ | | | | |
| | (85 wt. %) | | | | |

### b) Electrochemical Behavior

This example illustrates the electrochemical behavior of electrochemical cells as described in Example 2(a).

FIG. 6 presents charge and discharge profiles for two comparative cells (Cell 1). Charge and discharge were carried out in (1) at a cycling rate of 0.1 C between about 2.0 V and about 4.8 V vs. Li⁺/Li, and in (2) between about 2.0 V and about 4.6 V vs. Li⁺/Li. Charge and discharge were carried out at a temperature of about 25° C. Results are presented for a second discharge and charge cycle.

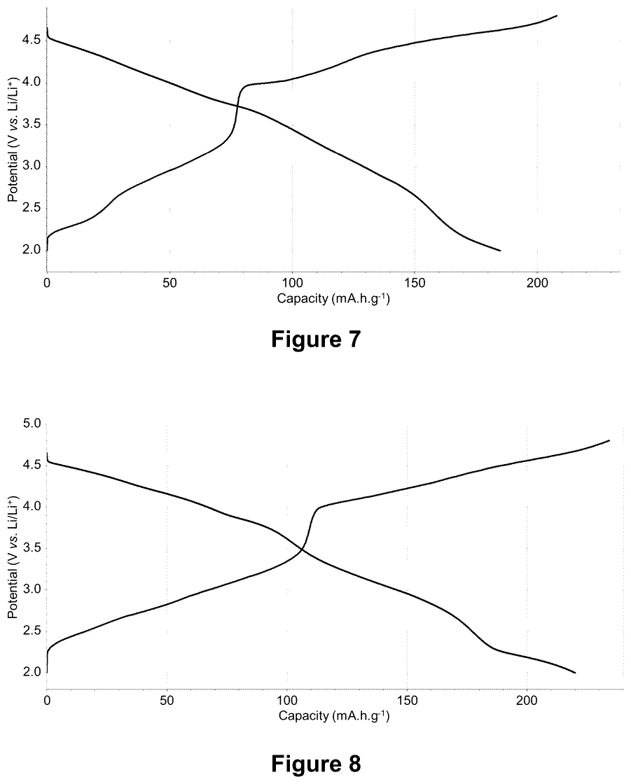

FIG. 7 presents a second charge and discharge profile for Cell 2. Charge and discharge were performed at a cycling rate of 0.1 C between about 2.0 V and about 4.8 V vs. Li⁺/Li. Charge and discharge were carried out at a temperature of about 25° C.

FIG. 8 presents a charge and discharge profile for Cell 3. Charge and discharge were performed at a cycling rate of 0.1 C between about 2.0 V and about 4.8 V vs. Li⁺/Li. Charge and discharge were carried out at a temperature of about 25° C. Results are presented for a second charge/discharge cycle.

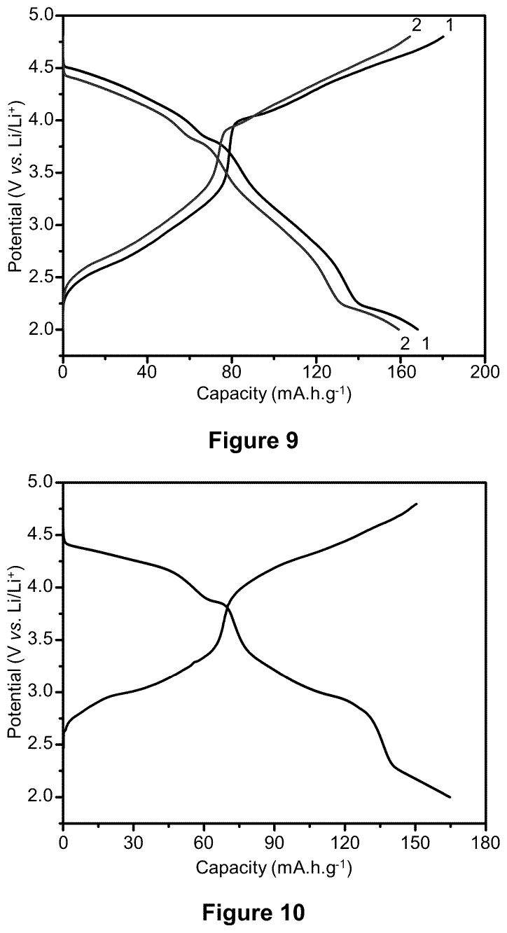

FIG. 9 presents charge and discharge profiles for Cell 4. Charge and discharge were performed at a cycling rate of 0.1 C between about 2.0 V and about 4.8 V vs. Li⁺/Li. Charge and discharge were carried out at a temperature of about 25° C. Results are presented for a second (1) and a fifth (2) charge and discharge cycle.

FIG. 10 presents a charge and discharge profile for Cell 5. Charge and discharge were performed at a cycling rate of 0.1 C between about 2.0 V and about 4.8 V vs. Li⁺/Li. Charge and discharge were carried out at a temperature of about 25° C. Results are presented for a second charge and discharge cycle.

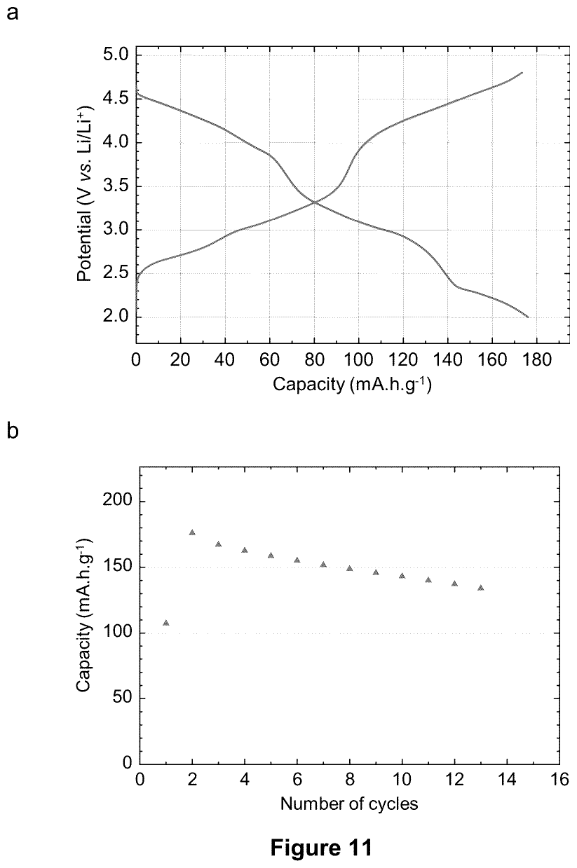

FIG. 11(a) presents charge and discharge profiles for Cell 6. Charge and discharge were performed at a cycling rate of 0.1 C between about 2.0 V and about 4.8 V vs. Li⁺/Li. Charge and discharge were carried out at a temperature of about 25° C. FIG. 11(b) is a graph showing the capacity as a function of the number of cycles obtained for Cell 6.

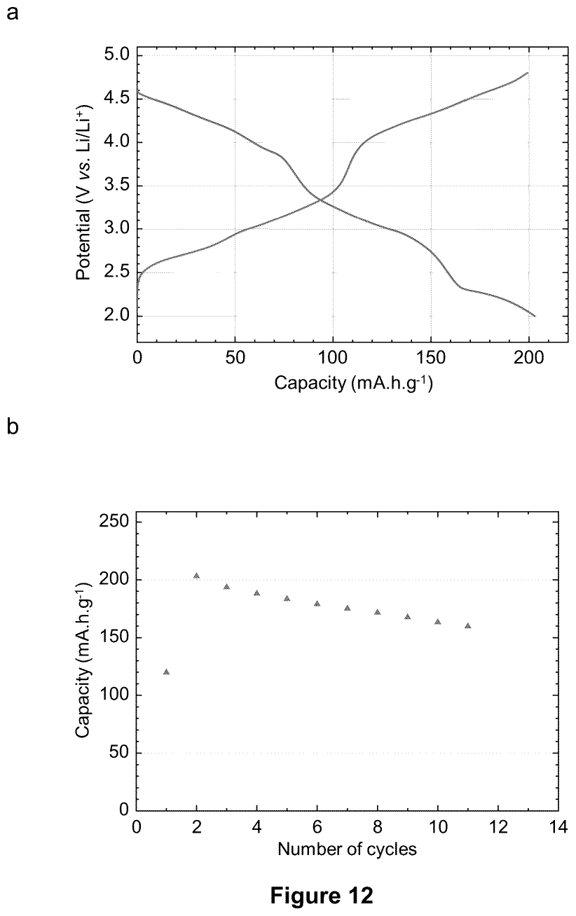

FIG. 12(a) presents charge and discharge profiles for Cell 7. Charge and discharge were performed at a cycling rate of 0.1 C between about 2.0 V and about 4.8 V vs. Li⁺/Li. Charge and discharge were carried out at a temperature of about 25° C. FIG. 12(b) is a graph showing the capacity as a function of the number of cycles obtained for Cell 7.

The capacity, voltage, and specific energy delivered by Cells 1 to 5 are presented in Table 2.

TABLE 2
Capacity, voltage and specific energy delivered
by the electrochemical cells in Table 1

| | | | | Specific |
|---|---|---|---|---|
| | Capacity | | Voltage | energy |
| Cell | (mAh · g⁻¹) | | (V) | (Wh/kg) |
| Cell 1 | Second discharge | | 3.26 | 864 |
| (comparative cell) | 265 | | | |
| Cell 2 | Second discharge | | 3.78 | 726 |
| | 192 | | | |
| Cell 3 | Second discharge | | 3.51 | 772 |
| | 220 | | | |
| Cell 4 | Second discharge | Fifth discharge | 3.69 | 621 |
| | 169 | 160 | | |

| | | | |
|---|---|---|---|
| Cell 5 | Second discharge | 3.81 | 624 |
| | 165 | | |
| Cell 6 | Second discharge | 3.32 | 587 |
| | 177 | | |
| Cell 7 | Second discharge | 3.33 | 676 |
| | 203 | | |

As can be observed in Table 2, the presence of iron ions substantially increases the average working potential of the electrochemically active material. Table 2 also shows that the electrochemical properties of the electrochemically active material can be substantially improved by the partial substitution of sodium ions by lithium ions and/or by the partial substitution of manganese ions by titanium ions.

Numerous modifications could be made to any of the embodiments described above without departing from the scope of the present invention as contemplated. The references, patents or scientific literature documents referred to in the present application are incorporated herein by reference in their entirety for all purposes.

What is claimed is:

1. An electrochemically active material comprising lithium-substituted iron-doped tunnel-type oxide of sodium, manganese, and at least one metallic element of formula NaₐLi_{b}Fe_{c}Mn_{d}MₑO₂, wherein a is a number such that 0<a<0.22; b is a number such that 0.18<b<0.40 and is such that a+b is 0.38<a+b<0.62; c is a number such that 0<c≤0.40; d is a number such that 0.44<d<1; e is a number such that c+d+e=1; and M is selected from manganese (Mn), titanium (Ti), vanadium (V), nickel (Ni), cobalt (Co), chromium (Cr), molybdenum (Mo), zirconium (Zr), tin (Sn), ruthenium (Ru), other similar metals, and a combination of at least two thereof.

2. Electrochemically active material according to claim 1, wherein M is selected from manganese (Mn), titanium (Ti), vanadium (V), nickel (Ni), cobalt (Co), chromium (Cr), molybdenum (Mo), zirconium (Zr), ruthenium (Ru), other similar metals, and a combination of at least two thereof, and preferably M is titanium (Ti).

3. (canceled)

4. Electrochemically active material according to claim 1, wherein a is a number such that 0.01<a<0.22, or 0.02<a<0.22, or 0.03<a<0.22, or 0.04<a<0.22, or 0.05<a<0.22, or 0.06<a<0.22, or 0.07<a<0.22, or 0.08≤a≤0.21, and preferably a is a number such that 0.08≤a≤0.21.

5. (canceled)

6. Electrochemically active material according to claim 1, wherein b is a number such that 0.19<b<0.40, or 0.20≤b<0.40, or 0.20≤b<0.39, or 0.20≤b≤0.38, and preferably b is a number such that 0.20≤b≤038.

7. (canceled)

8. Electrochemically active material according to claim 1, wherein c is a number such that 0.05<c≤0.40, or 0.10<c≤0.40, or 0.15<c≤0.40, or 0.20<c≤0.40 or 0.25<c≤0.40 or 0.30≤c<0.40, and preferably c is a number such that 0.30≤c≤0.40.

9. (canceled)

10. Electrochemically active material according to claim 1, wherein d is a number such that 0.44<d<1, or 0.44<d<0.95, or 0.44<d<0.90, or 0.44<d<0.85, or 0.44<d<0.80, or 0.44<d<0.75, or 0.44<d<0.70, or 0.44<d<0.65, or 0.44≤d<0.60, or 0.44<d<0.555, and preferably d is a number such that 0.44≤d≤0.55.

11. (canceled)

12. Electrochemically active material according to claim 1, wherein the lithium-substituted iron-doped tunnel-type oxide of sodium, manganese, and at least one metallic element is selected from the group consisting of Na_{0.10}Li_{0.33}Fe_{0.34}Mn_{0.44}Ti_{0.22}O₂, Na_{0.08}Li_{0.38}Fe_{0.30}Mn_{0.55}Ti_{0.15}O₂, Na_{0.20}Li_{0.24}Fe_{0.34}Mn_{0.55}Ti_{0.11}O₂, Na_{0.21}Li_{0.20}Fe_{0.40}Mn_{0.30}Ti_{0.10}O₂, Na_{0.10}Li_{0.40}Fe_{0.08}Mn_{0.81}Ti_{0.11}O₂, and Na_{0.10}Li_{0.40}Fe_{0.11}Mn_{0.78}Ti_{0.11}O₂.

13. An electrode material comprising the electrochemically active material as defined in claim 1.

14. Electrode material according to claim 13, further comprising an electronically conductive material preferably selected from the group consisting of carbon black, acetylene black, graphite, graphene, carbon fibers, carbon nanofibers, carbon nanotubes, and a combination of at least two thereof.

15. (canceled)

16. Electrode material according to claim 14, wherein the electronically conductive material comprises carbon black, preferably wherein the carbon black is super P™ carbon or Ketjen™ carbon.

17-18. (canceled)

19. Electrode material according to claim 14, wherein the electronically conductive material comprises carbon fibers, preferably wherein the carbon fibers are vapor grown carbon fibers (VGCFs).

20. (canceled)

21. Electrode material according to claim 13, further comprising a binder preferably selected from the group consisting of a polyether type polymer, fluoropolymer, and a water-soluble binder.

22. (canceled)

23. Electrode material according to claim 21, wherein the binder is a fluoropolymer, preferably wherein the fluoropolymer is polyvinylidene fluoride (PVDF).

24. (canceled)

25. Electrode material according to claim 13, further comprising an additive preferably selected from the group consisting of ionic conductors, inorganic particles, glass particles, ceramic particles, salts, and other similar additives.

26. (canceled)

27. An electrode comprising the electrode material as defined in claim 13 on a current collector.

28. (canceled)

29. An electrochemical cell comprising a negative electrode, a positive electrode, and an electrolyte, wherein the positive electrode is as defined in claim 27.

30. Electrochemical cell according to claim 29, wherein the negative electrode comprises an alkali metal, an alloy comprising an alkali metal, or a prelithiated electrochemically active material, preferably the negative electrode comprises metallic lithium or an alloy comprising metallic lithium, and more preferably the negative electrode comprises metallic lithium.

31-32. (canceled)

33. Electrochemical cell according to claim 29, wherein the electrolyte is a glass or ceramic electrolyte.

34. Electrochemical cell according to claim 29, wherein the electrolyte is (i) a liquid electrolyte comprising a salt in a solvent, (ii) a gel electrolyte comprising a salt in a solvent and optionally a solvating polymer, or (iii) a solid polymer electrolyte comprising a salt in a solvating polymer.

35-37. (canceled)

38. Electrochemical cell according to claim 34, wherein the salt is a lithium salt preferably selected from the group consisting of lithium hexafluorophosphate (LiPF₆), lithium bis(trifluoromethanesulfonyl)imide (LiTFSI), lithium bis(fluorosulfonyl)imide (LiFSI), lithium 2-trifluoromethyl-4,5-dicyanoimidazolate (LiTDI), lithium 4,5-dicyano-1,2,3-triazolate (LiDCTA), lithium bis(pentafluoroethylsulfonyl)imide (LiBETI), lithium tetrafluoroborate (LiBF₄), lithium bis(oxalato)borate (LiBOB), lithium nitrate (LiNO₃), lithium chloride (LiCl), lithium bromide (LiBr), lithium fluoride (LiF), lithium perchlorate (LiClO₄), lithium hexafluoroarsenate (LiAsF₆), lithium trifluoromethanesulfonate (LiSO₃CF₃)(LiTf), lithium fluoroalkylphosphate Li[PF₃(CF₂CF₃)₃](LiFAP), lithium tetrakis(trifluoroacetoxy)borate Li[B(OCOCF₃)₄](LiTFAB), lithium bis(1,2-benzenediolato(2-)-O,O′)borate[B(C₆O₂)₂](LiBBB), and a combination of at least two thereof, and preferably the lithium salt is lithium hexafluorophosphate (LiPF₆).

39. (canceled)

40. A battery comprising at least one electrochemical cell as defined in claim 29, wherein said battery is preferably selected from the group consisting of a lithium battery, a lithium-ion battery, a solium battery, a sodium-ion batter, a potassium battery, a potassium-ion battery, a magnesium battery, and a magnesium-ion battery, and more preferably said battery is a lithium battery or a lithium-ion battery.

41-42. (canceled)
